(19) United States
(12) Patent Application Publication
(10) Pub. No.: US 2011/0016305 A1
(43) Pub. Date: Jan. 20, 2011

(54) SYSTEM AND METHOD FOR TRANSFORMING INFORMATION

(76) Inventor: Robert Wayne Crull, Edmond, OK (US)

Correspondence Address: DUNLAP CODDING, P.C., PO BOX 16370, OKLAHOMA CITY, OK, 73113, US

(21) Appl. No.: 12/505,127

(22) Filed: Jul. 17, 2009

(51) Int. Cl. H04L 9/28; H04L 29/06; H04L 9/14

(52) U.S. Cl. 713/150; 380/28

(57) ABSTRACT

A method for transforming information, comprising the steps of encoding two or more original messages into a single encoded information and decoding the single encoded information using multiple different decoding schemes to recover the two or more original messages.

### BACKGROUND OF THE INVENTION

1. Field of the Invention

This invention relates to a system and method for transforming information, and more particularly, but not by way of limitation, to a system and method for transforming information which operates to encode two or more original messages into a single encoded information and decode the single encoded information using multiple different decoding schemes to recover the two or more original messages.

2. Brief Description of Related Art

The encoding or “encryption” and decoding or “decryption” of messages is well known in the art. Encryption is the process of converting a message, usually a plaintext message, into ciphertext which can be decoded back into the original message via the use of a cipher algorithm and/or an encryption key.

Cipher algorithms have been utilized for centuries and include techniques such as Runestones. One example of a Runestone is the Heavener Runestone located in Oklahoma. The Heavener Runestone includes a message inscribed onto the face of a stone tablet. The message inscribed on the Runestone comprises individual symbols which are thought to possibly represent other letters or separate messages. Though no one is exactly sure of the exact meaning of the message or messages encrypted into the Heavener Runestone, many have provided possible and sometimes disparate interpretations of the Runestone.

Modern encryption techniques are implemented on computer systems for securely transmitting information over computer networks. In computer systems, the cipher algorithm along with the encryption key is known as the schema, and the schema is used in the encryption and decryption of data. The type and length of the encryption keys utilized depends upon the cipher algorithm and the amount of security needed. In conventional symmetric encryption a single encryption key is used. With this encryption key, the sender can encrypt a message and a recipient can decrypt the message. In asymmetrical encryption, two or more encryption keys are utilized, commonly a private key and a public key.

Furthermore, the use of encoding/decoding schemes for encoding two messages using exclusive OR logic operator (XOR) and then decoding the encoded information using the encoded information and one of the messages is well known. Such schemes can be represented mathematically as message A XOR message B=encoded information C; message B XOR encoded information C=message A; message A XOR encoded information C=message B. In these schemes, only two messages can be encoded to form the encoded information, and at least one of the messages must be used to decode the encoded information.

Therefore, a need exists for a system and method for transforming information which operates to encode two or more original messages into a single encoded information and decode the single encoded information using multiple different decoding schemes to recover the two or more original messages. Furthermore, there exists a need for a method of transforming, storing, or displaying information utilizing multiple types of objects suitable for transmitting a message such as a language, geometrically, geometrical shapes, or combinations thereof to encode/decode two or more original messages utilizing a single encoded information. It is to such a system and method that the present invention is directed.

### BRIEF DESCRIPTION OF THE DRAWINGS

FIG. 1 is a schematic diagram of a method for transforming information, in accordance with the present invention.

FIG. 2 is a schematic diagram of a processing environment for use with the method of FIG. 1.

FIG. 3 is a schematic diagram of a client computer for use with the method of FIG. 1.

FIG. 4 is a schematic diagram of a system for implementing the method of FIG. 1.

FIGS. 5 and 6 are diagrams of alternative systems for implementing the method of FIG. 1.

FIG. 7 is a schematic diagram of an implementation of the method of FIG. 1 provided for illustrative purposes.

FIG. 8 is a perspective view of a device having a plurality of bytes for encoding messages thereon.

FIG. 9 is a perspective view of the front of one of the bytes of FIG. 8.

FIG. 10 is a flow chart of the method of FIG. 1.

### DETAILED DESCRIPTION OF EXEMPLARY EMBODIMENTS

After considering the following description, those skilled in the art will clearly realize that the teachings of our present invention can be utilized in any one of an extremely wide range of applications where fast and secure encryption of information is needed, such as for real-time video applications or real-time encryption of keyboard entry, and/or where processing power is limited, such as for use in remote control or other “small” devices. Furthermore, the present invention may be utilized for the compression of information. Information, in this instance and as the term will be used hereinafter, is defined as generically encompassing all information that can be stored digitally, regardless of its specific content, i.e., whether that information is executable program code or data of one form or another. For purposes of simplification, we will discuss our invention in the context of use in a client or client-server processing environment to encrypt messages which are to be communicated over an insecure network, such as the Internet.

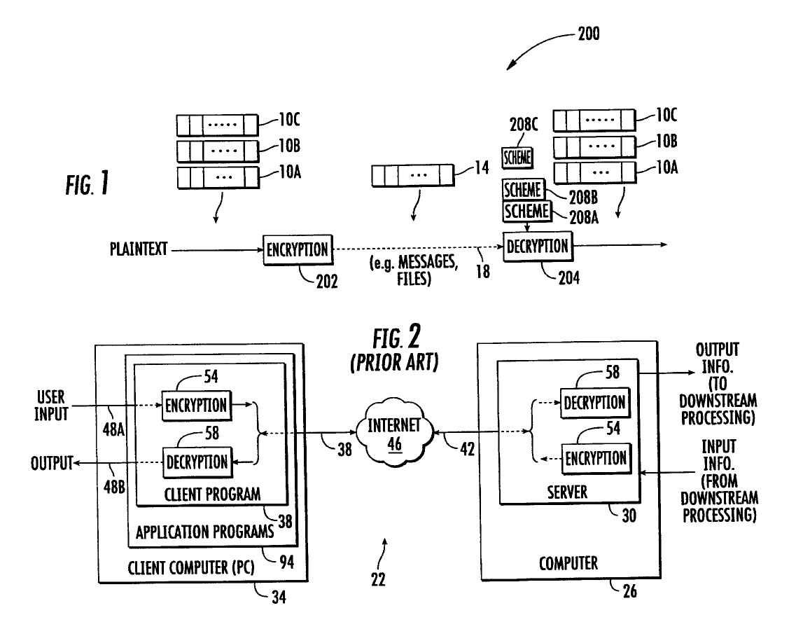

FIG. 1 depicts a diagram of an overall cryptographic process that incorporates the teachings of the present invention. As shown, incoming original messages 10A, 10B, and 10C emanating from an originating (source) location is organized into so-called “messages”. It will be understood that the original messages 10 may include letters from any alphabet, numbers, arbitrary symbols or combinations thereof. It will be understood that the two or more messages 10A-10C may include information such as text, images, video, sound, data, DNA sequences or combinations thereof. Each such original message 10A-10C, contains a succession of characters, of any length. Each such plaintext word or collection of symbols is encrypted, through our inventive cryptographic technique as will be described in detail below into a corresponding single encoded message 14. The message 14 is formed by encoding the original messages 10A-10C into a single encoded information such as a string of characters selected from any alphabet, numbers, arbitrary symbols or combinations thereof. It will be understood that the single encoded information 14 may include information such as text, images, video, sound, data, physical objects such as blocks or cubes or waves of light or modulations of waves of light or combinations thereof. The resulting message 14 is then stored or transferred, through a given modality, e.g., a network communication channel, represented by dashed line 18, to a recipient (destination) location. Here, the message 14 is decrypted via multiple decoding schemes to yield recovered original messages 10A-10C, which are identical in all aspects to original messages 10A-10C.

### Illustrative Processing Environment

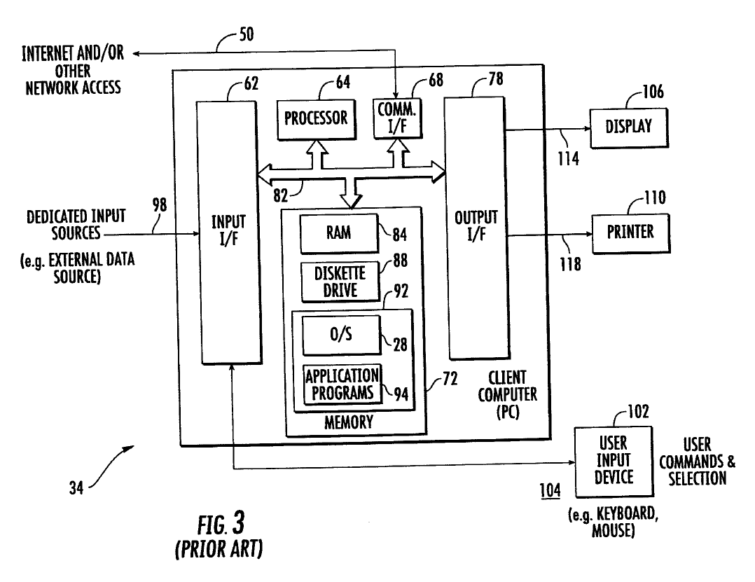

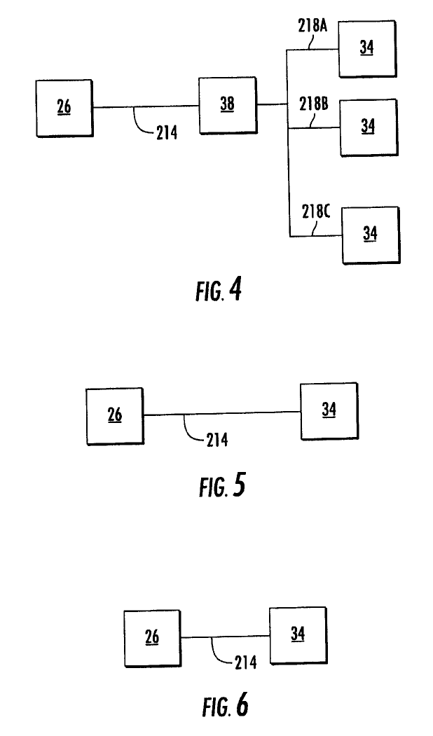

Referring now to FIG. 2, a computing environment 22 contains computer 26 which implements server 30, the latter illustratively being a web server. A number of individual remotely-located client computers, each being illustratively a personal computer (PC), of which only one such client, i.e., client computer 34, is specifically shown, is connected using appropriate communications channels, such as channels 38 and 42, through an insecure communications network, here shown as illustratively Internet 46, to computer 26. A user (not specifically shown), stationed at client computer 34 and desirous of obtaining information from the server can invoke a corresponding client program at that computer. The client program forms one of a number of application programs 38 that collectively reside within and are executed by client computer 34. Though the client program is specifically shown as residing within the application programs, the former can also be implemented as a component, such as a web browser, of an operating system (O/S), for example, of O/S 28 shown in FIG. 3. Server 30, shown in FIG. 2, can implement any of a wide variety of application functions including, for example, a commerce server, a banking server, an electronic mail or a file server. As to electronic commerce, the user might desire to conduct a commercial transaction through server 30 that involves providing (as symbolized by line 48A) information to the server, such as an account number of the user at a financial institution and payment instructions to transfer funds to a payee, or obtaining (as symbolized by line 48B) information from the server, such as available account or credit balances of the user, which, in either event, is confidential to that user and needs to be encrypted.

Network 50, being illustratively the Internet, is susceptible to being compromised by a third-party. In that regard, the third party could intercept a message then being carried over the network and emanating from, e.g., client computer 34, for, e.g., an on-going financial transaction involving a user situated threat.

To safeguard the confidential or proprietary nature of the information, passing over network 50, between client computer 34 and computer 26, from third-party access, both the client program 38 and server 30 each utilize cryptographic communication through incorporation of encryption 54 and decryption 58 therein. As such, packetized messages destined for network carriage and generated by one network application peer, either client program 38 or server 30 can be encrypted at a TCP/IP layer by encryption procedure 54 therein to yield corresponding packetized messages, which, in turn, are then each transmitted over network 50 to the other network application peer. It will be understood that encryption procedure 54 is not limited to use at a TCP/IP layer level and the encryption procedure 54 may be utilized entirely outside of any packetized, network related application. Similarly, packetized messages received, from the network, by each of the peers can be decrypted by decryption 58 therein, at a TCP/IP layer, to yield an appropriate recovered packetized plaintext message. Encryption 54 and decryption 58 are inverse procedures of each other and can be provided, within client computer 34, through illustratively client program 38.

### Client Computer Description

Referring now to FIG. 3, client computer 34 comprises input interfaces (I/F) 62, processor 64, communications interface 68, memory 72 and output interfaces 78, all conventionally interconnected by bus 82. Memory 72, which generally includes different modalities, including illustratively random access memory (RAM) 84 for temporary data and instruction store, diskette drive(s) 88 (or flash memory) for exchanging information, as per user command, with floppy diskettes or a portable driver, and non-volatile mass store 92 that is implemented through a hard disk, typically magnetic in nature, although flash type memory components may likewise be utilized in accordance with the present invention. Mass store 92 may also contain a CD-ROM or other optical media reader (not specifically shown) (or writer) to read information from (and write information onto) suitable optical storage media. In addition, mass store 92 also stores operating system (O/S) 28 and application programs 94; the latter illustratively containing client program 38 (see FIG. 2) which incorporates the inventive cryptographic technique. O/S 28, shown in FIG. 3, may be implemented by any conventional operating system, such as WINDOWS NT, Windows XP, Linux, MAC O/S, Unix, Palm O/S and the like. Given that, we will not discuss any components of O/S 28 as they are all irrelevant. Suffice it to say, that the client program, being one of application programs 38, executes under control of the O/S 28.

As shown in FIG. 3, incoming information can arise from two illustrative external sources: network supplied information, e.g., from the Internet and/or other networked facility, through network connection 50 to communications interface 68, or from a dedicated input source, via path(es) 98, to input interfaces 62. Dedicated input can originate from a wide variety of sources, e.g., an external data source. In addition, input information, in the form of files or specific content therein, can also be provided by inserting a diskette or flash drive containing the information into diskette drive 88 from which computer 34, under user instruction, will access and read that information from the diskette. Input interfaces 62 contain appropriate circuitry to provide necessary and corresponding electrical connections required to physically connect and interface each differing dedicated source of input information to computer system 34. Under control of the operating system, application programs 38 exchange commands and data with the external sources, via network connection 50 or path(es) 98, to transmit and receive information typically requested by a user during program execution.

Input interfaces 62 also electrically connect and interface user input device 102, such as a keyboard and a mouse, to computer system 34 via wired or wireless lead 104. Display 106, such as a conventional color monitor, and printer 110, such as a conventional laser printer, are connected, via wired or wireless leads 114 and 118, respectively, to output interfaces 78. The output interfaces 78 provide requisite circuitry to electrically connect and interface the display and printer to the computer system. As one can appreciate, our present inventive technique can operate with any type of digital information regardless of the modalities through which client computer 34 will obtain that information, store and/or communicate that information.

Furthermore, since the specific hardware components of computer system 34 as well as all aspects of the software stored within memory 72 (including TCP/IP layer encryption in general and related TCP/IP processing), apart from the modules that implement the present invention, are conventional and well-known, they will not be discussed in any further detail. Generally speaking, computer 26 has an architecture that is quite similar to that of client computer 34.

### Inventive Cryptographic Technique

Referring back to FIG. 1, the inventive concept disclosed herein includes a method 200 for transforming information, comprising the step of encrypting information 202 by encoding two or more original messages 10A-10C into a single encoded information 14; and the step of decrypting information 204 by decoding the single encoded information 14 using multiple different decoding schemes not requiring the two or more original messages 10A-10C to recover the two or more original messages 10A-10C.

It will be understood that the single encoded information 14 and the original messages 10A and 10B can be represented in one or more languages. That is, the original messages 10A and 10B can be encoded into the single encoded information 14 utilizing any known language such as ASCII, DNA code, English, and the like. The single encoded message 14 may be perceivable by a recipient who can process the language utilizing one or more decoding schemes to recover one or more original messages 10A and 10B.

The method 200 as described above allows two or more original messages 10A-10C to be combined into a single encoded information 14 and communicated to two or more recipients or client computers 34. The method is executable via one or more of the computer systems 26 and 34 as described above. Each of the decoding schemes 208A-208C includes at least one of a ciphering algorithm (see FIG. 7, 308) and a decryption key for recovering the two or more original messages 10A-10C. When the recipient receives the single encoded information 14 along with one of the decoding schemes 208A-208C, the recipient, or the recipient's computer 34 may use the ciphering algorithm and/or the decryption key of the decoding scheme to recover one of the two or more original messages.

Referring now to FIGS. 1, 2 and 4 collectively, in one embodiment, the method is executable by encoding the two or more original messages 10A-10C into a single encoded information 14 via a first computer 26 (a.k.a. the encryption computer) or an application program “first computer module” running on the first computer 26. A second computer 34 (a.k.a. a decryption computer) or an application program “second computer module” running on the second computer 34 receives the single encoded information via one or more signal paths 214 along with the one or more decoding schemes 208A-208C for recovering each of the two or more original messages 10A-10C. The single encoded information 14 is decrypted by the second computer 34 to recover the original messages 10A-10C. Next, each of the two or more decrypted original messages 10A-10C is provided to separate computers 34 via signal paths 218A-218C based upon information contained in the multiple decoding schemes 208A-208C.

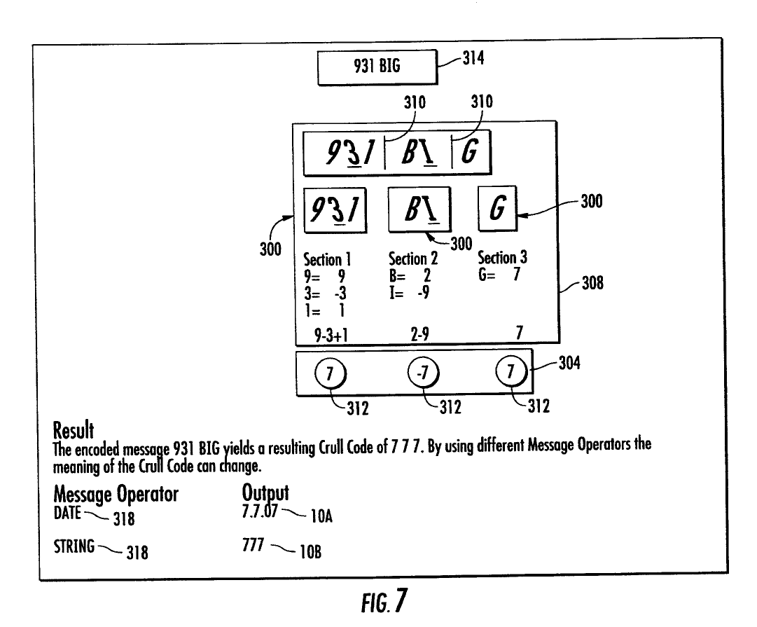

Referring now to FIGS. 1, 2 and 5 collectively, in another embodiment, the method 200 is executable by encoding the two or more original messages 10A-10C into a single encoded information 14 via a first computer 26 (a.k.a. an encryption computer) or an application program “first computer module” running on the first computer 26. One or more second computers 34 (a.k.a. a decryption computer) or an application program “second computer module” running on the second computer 34 receives the single encoded information via one or more signal paths 214 along with the one of the multiple decoding schemes 208A-208C for recovering one of the two or more original messages 10A-10C.

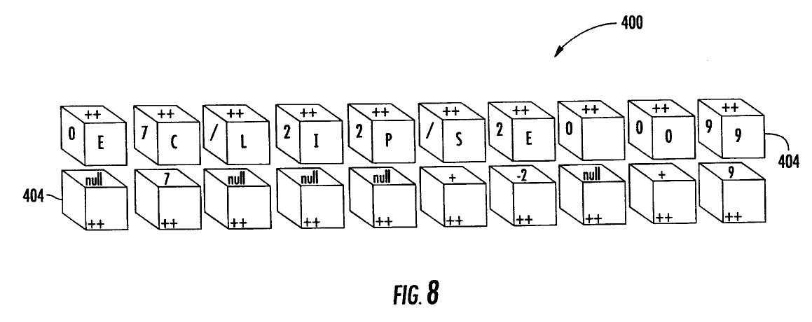

Referring now to FIGS. 1, 2 and 6 collectively, in another embodiment, the method is executable by encoding the two or more original messages 10A-10C into a single encoded information 14 via a first computer 26 (a.k.a. an encryption computer) or an application program “first computer module” running on the first computer 26. A second computer 34 (a.k.a. a decryption computer) or an application program “second computer module” running on the second computer 34 receives the single encoded information 14 via one or more signal paths 214 along with the one of the multiple decoding schemes 208A-208C for recovering the two or more original messages 10A-10C. In this embodiment, the method is provided for compressing data by allowing multiple messages 10A-10C to be encoded into a single message 14, the multiple messages 10A-10C being recoverable by the second computer 34. Unlike common encrypted data which requires individual encryption, decoding schemes and separate communication for each message, the present method provides for compressing information as many messages can be combined into a single encoded message.

### Example One

Referring now to FIG. 7, by way of non-limiting example, two or more original messages 10A and 10B may be combined into a single encoded message 14 such as a cryptogram of arbitrary symbols. The arbitrary symbols may include, for example, letters from any language or symbols such as wingdings, or Elder Futhark symbols.

To decode the original messages 10A and 10B, a recipient is provided with the encoded message 314 and the decoding scheme 308 which provides instructions for recovering the original messages 10A and 10B. In one embodiment, the decoding scheme 308 provides that the encoded message 314 can be broken into two or more separate segments 300 and processed using mathematical functions. The resulting value, called an “intermediate code” 304 can be further decoded from the single encoded message 314 by using one or more message operators 318 to obtain each of the original messages 10A and 10B. Additionally, the decoding scheme 308 may provide that the recipient decrypted messages 10A and 10B use a unique set of operator keys. In one embodiment, each of the symbols in the set of arbitrary symbols may be capable of representing both positive and negative values. For example, symbols with positive values may be italicized forwardly and symbols with negative values may be underlined. A negative symbol such as “A” will have inverse properties of the corresponding positive symbol “A” such that when any function is applied a negative symbol in combination with a positive symbol of inverse value, the end result is a null or zero value. It will be understood that standard mathematical rules apply when interpreting such positive and negative symbols unless otherwise required within the applied function for that particular symbol.

The method of generating an intermediate code to decrypting the encoded message 14 and recover the original messages 10A and 10B is executed by processing an encoded message 14 via one or more decoding schemes 308. The recipient is provided with the single encoded message 14 and a decoding scheme 308 which may include an inverse mathematical algorithm or “cipher algorithm” which can include a segment operator (not shown), segment size 300, and message operator 318. Different decoding schemes 308 may be sent to various recipients along with the encoded message 314 such that each of the recipients may decrypt the same encoded message 314 and receive an original message.

As stated previously, it will be understood that the single encoded information 14 and the original messages 10A and 10B can be represented in one or more languages. That is, the original messages 10A and 10B may be encoded into the single encoded information 14 utilizing any language such as ASCII, DNA code, English, and the like. In one embodiment, the encoded message 14 is a message or “collection of symbols” which the recipient divides into a plurality of segments 300 by control characters 310 (in this case a “|” or pipe symbol according to the decoding scheme 308. Segment operators (not shown) follow each of the control characters 310 and may be as simple as addition, subtraction, or other mathematical operators or may be an advanced operator such as a generic kernel function. Each of the segments 300 is processed via the segment operator following the control character 310 to produce a segment value 312. It will be understood that when no segment operator is provided, the default segment operator is addition. Next, the segment values are combined to produce an intermediate code 304. Finally, the recipient interprets the intermediate code 304 via the message operator 318 to produce one of the original messages 10A.

It will be understood that the single encoded information 14 is encrypted with the original message 10A and 10B in reverse manner as described above with respect to decrypting or decoding the single encoded information 14 to recover the original messages 10A and 10B. Therefore, to encode the original messages 10A and 10B into the single encoded in formation 14, a string or characters is selected as the single encoded information 14 such as a word, sentence, date, or other collection of symbols, letters or numbers. The original messages 10A and 10B are encoded into the single encoded information 14 by determining which segment sizes 300 and segment operators when applied to the single encoded information 14 will produce segment values 312 that will convert the single encoded message 14 into a predetermined intermediate code 304. The intermediate code 304 is then interpreted or otherwise combined with a message operator 318 to recover the original messages 10A and 10B.

One specific example of recovering two or more messages from a single encoded information 314 begins with providing the single encoded message 314 representative of a license plate number 931 BIG. The single encoded message 314 is communicated to a recipient along with a decoding scheme 308. The encoded message 314 is processed by inserting control characters 310 into the message 314 as described in the decoding scheme 308 and assigning positive or negative values to the symbols to produce the following message: 931|BI|G, where the first segment 300 is 931, the second segment 300 is BI, and the third segment 300 is G. In this example each of the letters of the alphabet is represented by a numerical value such that A=1, B=2, C=3 and so on. Mathematical operations are performed on each of the segments 300 such that segment one 300 is represented by the equation 9+(−3)+1=7, segment two 300 is represented by the equation 2+(−9)=−7 and segment three 300 is represented by the equation 7=7. The mathematical operations produce a intermediate code 304 of 7, −7, 7. By applying various message operators 318 to the intermediate code 304 of 7, −7, 7 each recipient may recover various original messages 10A and 10B. For example, a message operator 318 of “DATE” would decrypt an original message 10A of 7/7/07 from the intermediate code 304. A second message operator 318 of “STRING” would decrypt an original message 10B of 777 from the same intermediate code 304. One of ordinary skill in the art will readily appreciate that many different types of message operators could be used to decrypt a single encoded message 314 using multiple decoding schemes 308 to recover any number of different original messages.

It will be understood that because the single encoded information can be interpreted utilizing multiple deciphering algorithms to encode one or more original messages, it follows that one or more original messages may be encoded into a single bit of information rather than a string of bits such that the single bit of information may be interpreted in multiple ways utilizing multiple deciphering algorithms to recover one or more original messages.

It will be further understood that the one or more original messages 10A and 10B may include information such as instructions or operators. For example the one or more original messages 10A and 10B may include data such as executable code or operators (such as Boolean or Mathematical) that can cause a processor running on a computer to cause one or more functions to perform one or more actions. Non-limiting examples of functions which are executable on a computer include the execution and/or operation of an application program, the operation of hardware, and the like.

### Example Two

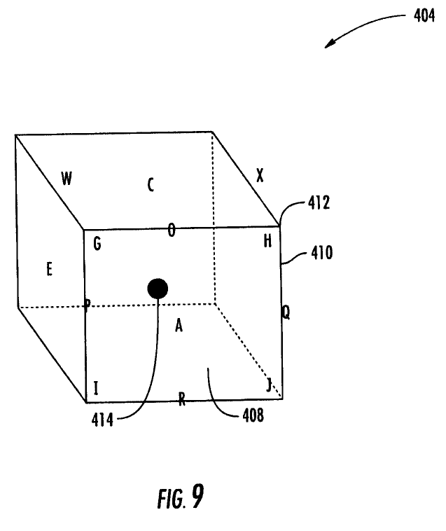

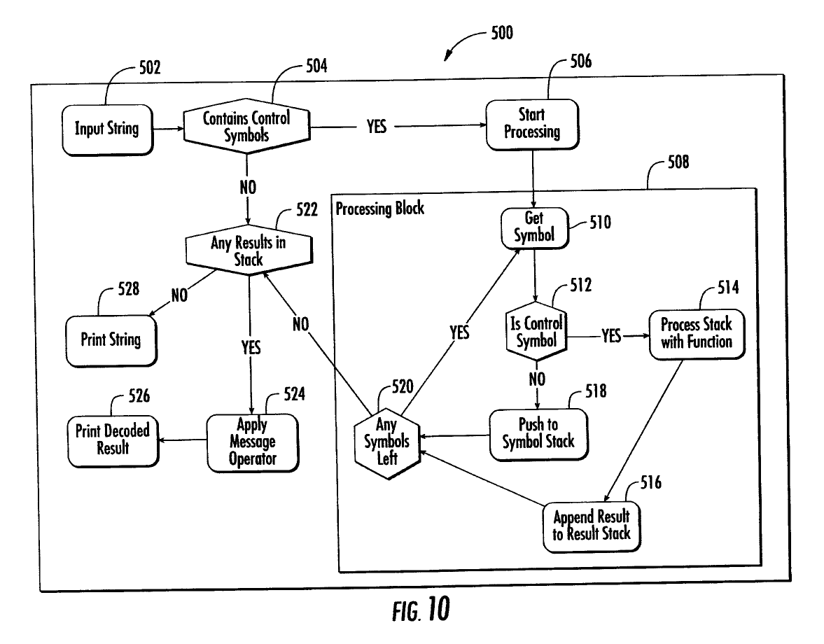

Referring now to FIGS. 8-9, this example utilizes an apparatus or device which can be inscribed or otherwise provided with indicia disposed at predetermined locations along the device for storing a single encoded message and one or more original messages thereon. This device allows for the encoding of multiple original messages, mathematical equations, or instructions into the single encoded message via a plurality of encoding/decoding schemes, one for each of the original messages. The single encoded message can be communicated to one or more recipients along with one or more of the decoding schemes which permit the recipients to decode the single encoded message and recover one or more of the original messages.

One non-limiting example of a device 400 that functions as described above will be described hereinafter. The device 400 may include one or more bytes 404 arranged into a predetermined pattern. In this example, the device 400 includes a plurality of bytes 404 arranged next to one another in a linear pattern. The bytes 404 may include three-dimensional geometrical figures of any shape and/or size, for example, pyramidal, cubic, polyhedrons, irregular polyhedrons, and the like. Furthermore, it will be understood that the device 400 may include bytes 404 have any number of differing two, three or multi-dimensional geometric shapes or other definable shapes such as a double helix structure representative of DNA. Each of the bytes 404 include at least two faces 408, at least three edges 410, and adjoining corners 412 formed by the adjoining of the two faces 408. In this embodiment, the bytes 404 include cubic geometrical figures with six faces 408, twelve edges 410, and eight corners 412, for a total of 26 possible data positions. Furthermore, the bytes 404 may include a central data position 414 that may be encoded to represent a decoding scheme as will be discussed in greater detail below. It will be understood that the bytes 404 comprising the device 400 may be identical in shape, or they may be different in shape from one another.

In this embodiment, as the bytes 404 are provided with 26 possible data positions, each of the letters of the English alphabet may be inscribed onto the bytes 404. It will be understood that the bytes 404 may include numbers, mathematical operators, and/or letters of the alphabet such that any English sentence may be represented. Furthermore, the bytes 404 may include special operators such as “Date” which indicate that the previous numeric characters can be used with the following numeric characters to produce a date, “Time” which indicates that the previous numeric characters can be used with the following numeric characters to produce a time message, “Increment (++)” indicates that the following number should be increased by one, and Concatenate (.) which indicates that the previous characters are to be concatenated with the characters which follow. The bytes 404 may also be inscribed with any type of symbol in addition to the ones disclosed thus far. The bytes 404 may be encoded to convey information representing instructional teachings, history, or even DNA sequences.

In operation, the single encoded message and the two or more original messages are separated into constituent characters to determine the message having the greatest number of characters. Once the message with the greatest number of characters has been determined, bytes 404 are selected in an amount equal to the number of characters in the message with the greatest number of characters such that each character of the longest message can be inscribed on the bytes 404 of the device 400. Next, the bytes 404 are arranged identically to one another, for example the bytes 404 are placed in a linear pattern with the same face of each byte 404 presented forwardly. Next, each character of the single encoded message is inscribed onto the same location on each of the bytes 404 such that the single encoded message is perceivable to an individual reading the device 400. It will be understood that the single encoded information may include no single encoded message such that the single encoded information is represented by a plurality of null characters such as “ø”. If there are more bytes 404 than characters in the single encoded message, the remaining bytes 404 are inscribed with null characters or noise characters such as “ø”.

Next, one of the original messages is inscribed onto the bytes 404 by rotating each of the bytes 404 in an identical manner such that each of the bytes 404 is rotated to show the same of one of a face, edge, or corner that does not contain a character from the single encoded message. The same operations of rotation and inscription can be repeated to inscribe the bytes 404 with a second original message, or any number of original messages not to exceed 25 original messages if the bytes 404 are cubes.

The decoding scheme utilized to decode the device 400 and recover the original messages includes information representing how the user may arrange the bytes 404 to display the single encoded message. Furthermore, the decoding scheme may include the directions of rotation necessary to reposition the bytes 404 in order to recover the one or more original messages.

In one embodiment, a plurality of bytes 404 are arranged linearly and identically to one another such that the faces 408 of the bytes 404 are all arranged forwardly. The single encoded message “Eclipse 09” is inscribed onto the faces of the bytes 404. The bytes 404 also include the original message “07/22/2009” inscribed onto the leftward faces of the bytes 404, and the original message “7−2+9” inscribed onto the back faces of the bytes 404. When the single encoded message is sent to a recipient along with the decoding scheme to rotate the bytes 404 to show the message of “07/22/2009”, the recipient can recover the original message of the date. Another recipient may be provided the same single encoded message along with the decoding scheme to rotate the bytes 404 to show the message of “7−2+9” instead of the message of “07/22/2009”.

Referring now to FIG. 10, shown therein is a flowchart of a method for transforming information 500. The method 500 may be utilized to process a single encoded information, for example, the string “931 BIG” as described in Example One. The method is executable on a computer system as disclosed above in the Client Computer Description section above. It will be understood that stacks of information may be accessible and stored in memory as described above.

The method begins with the step 502 of inputting a string of characters (a.k.a. the single encoded information, 14 of FIG. 1), for example, a word, a set of instructions, operators, or the like into the system. Next, the system branches to a step 504 to determine whether the string of characters contains any control symbols. If the system determines that the string of characters includes control symbols, the system branches to a step 506 of a decoding process 508 to decode the string of characters. The decoding process 508 is initiated with the steps of receiving 510 and analyzing 512 each of the symbols contained in the string of characters, also known as a symbol stack. If the symbol is determined by the system to be a control symbol, the system branches to step 514 and processes the stack of characters associated with the control symbol using one or more functions and/or operations which may be analogous to the decoding schemes disclosed above. The symbols processed via the decoding scheme are then appended or otherwise associated with a result stack in step 516. It will be understood that if the symbol is not a control symbol, the symbol is pushed back to the symbol stack in step 518. If any symbols remain after processing the symbol stack via the one or more decoding schemes or functions, the process may loop as shown in step 520 until the residual symbols have been processed by the one or more functions.

The system then branches to step 522 and the results stack is processed by the system utilizing one or more message operators in step 524 to recover one or more original messages which are then output in a manner perceivable by an individual or alternatively by another system in step 526.

If in the step 504 of determining whether the input string contains control symbols the string of characters does not contain any control symbols, the system branches to step 522 and determines whether there are any results currently stored within the results stack. If there are no results currently stored within the stack, the method branches to step 528 and the string of characters may be printed or otherwise output as an original message. If there are results stored in the results stack, the method branches to step 524 where the results are processed via one or more message operators to recover one or more original messages.

Changes may be made in the construction and the operation of the various components, elements and assemblies described herein or in the steps or the sequence of steps of the methods described herein without departing from the spirit and scope of the invention.

What is claimed is:

1. A method for transforming information, comprising the steps of:
encoding two or more original messages into a single encoded information; and
decoding the single encoded information using multiple different decoding schemes not requiring the two or more original messages to recover the two or more original messages.

2. The method of claim 1, further comprising the step of communicating the single encoded information to two or more distinct objects before the step of decoding the single encoded information.

3. The method of claim 2, wherein each of the two or more distinct objects is communicated one of the multiple different decoding schemes and utilizes the communicated decoding scheme to recover one of the two or more original messages.

4. The method of claim 1, further comprising the step of communicating the two or more original messages to a single recipient to compress the two or more original messages.

5. The method of claim 1, wherein each of the multiple different decoding schemes includes at least one of a cipher algorithm and a decryption key.

6. The method of claim 1, wherein the two or more messages include information consisting of: text, images, video, sound, data, DNA sequences, or combinations thereof.

7. The method of claim 1, wherein the single encoded information include information consisting of: text, images, video, sound, data, physical objects such as blocks or cubes or waves of light or modulations of waves of light or combinations thereof.

8. The method of claim 1, wherein in the step of encoding two or more original messages into a single encoded information, the step includes:
providing a single encoded information having a string of two or more characters;
inserting one or more control characters and one or more segment operators in between the one or more of the characters of the string to separate the one or more characters into one or more segments, wherein each of the segments includes a segment size corresponding to the number of characters in the segment;
utilizing the segment operator for each segment to convert the segments into an encoded character such that each of the one or more segments is represented by a single encoded character; and
utilizing two or more message operators to transform the encoded characters into two or more original messages.

9. The method of claim 8, wherein each of the decoding schemes includes the segment size, segment operator, and one of the two or more message operators corresponding to one of the two or more original messages.

10. The method of claim 1, wherein the two or more original messages include at least one of a computer executable code, one or more logical operators, and one or more mathematical operators.

11. A system for transforming information, the system comprising:
an encoding module for encoding two or more original messages into a single encoded information; and
a decoding module receiving the single encoded information from the encoding module, the decoding module decoding the single encoded information using multiple different decoding schemes not requiring the two or more original messages to recover the two or more original messages.

12. The system of claim 11, wherein the system includes a separate decoding module receiving the single encoded information and one of the one or more decoding schemes for each of the two or more original messages.

13. The system of claim 11, wherein each of the multiple different decoding schemes includes at least one of a cipher algorithm and an encryption key.

14. The system of claim 11, wherein the two or more messages can include information consisting of: text, images, video, sound, data, DNA sequences or combinations thereof.

15. The system of claim 11, wherein the single encoded information can include information consisting of: text, images, video, sound, data, physical objects such as blocks or cubes or waves of light or modulations of waves of light or combinations thereof.

16. A computer program product, comprising a computer usable medium having a computer readable program code embodied therein, said computer readable program code adapted to be executed to implement a method for transforming information, the method comprising the steps of:
encoding two or more original messages into a single encoded information; and
decoding the single encoded information using multiple different decoding schemes not requiring the two or more original messages to recover the two or more original messages.

17. The product of claim 16, further comprising the step of communicating the single encoded information to two or more distinct objects before the step of decoding the single encoded information.

18. The product of claim 16, wherein each of the two or more distinct objects is communicated one of the multiple different decoding schemes and utilizes the communicated decoding scheme to recover one of the two or more original messages.

19. The product of claim 16, further comprising the step of communicating the two or more original messages to a single recipient to compress the two or more original messages.

20. The product of claim 16, wherein each of the multiple different decoding schemes includes at least one of a cipher algorithm and an encryption key.

21. The product of claim 16, wherein the two or more messages includes information consisting of: text, images, video, sound, data, DNA sequences or combinations thereof.

22. The product of claim 16, wherein the single encoded information includes information consisting of: text, images, video, sound, data, physical objects such as blocks or cubes or waves of light or modulations of waves of light or combinations thereof.

23. The product of claim 16, wherein in the step of encoding two or more original messages into a single encoded information, the step includes:
providing a single encoded information having a string of two or more characters;
inserting one or more control characters and one or more segment operators in between the one or more of the characters of the string to separate the one or more characters into one or more segments, wherein each of the segments includes a segment size corresponding to the number of characters in the segment;
utilizing the segment operator for each segment to convert the segments into an encoded character such that each of the one or more segments is represented by a single encoded character; and
utilizing two or more message operators to transform the encoded characters into two or more original messages.

24. The product of claim 23, wherein each of the decoding schemes includes the segment size, segment operator, and one of the two or more message operators corresponding to one of the two or more original messages.

25. A method for transforming information, comprising the steps of:
encoding two or more original messages in a single encoded information onto a device;
decoding the single encoded information using the device and multiple different decoding schemes not requiring the two or more original messages to recover the two or more original messages.

26. The method of claim 25, wherein in the step of encoding the two or more original messages and the single encoded information, the two or more original messages and the single encoded information are inscribed onto at least a portion of a device utilizing multiple different decoding schemes for each of the two or more original messages.

27. The method of claim 26, wherein the multiple different decoding schemes includes moving the device in a predetermined manner for each decoding scheme.

28. The method of claim 25, wherein each of the multiple different decoding schemes includes at least one of a cipher algorithm and a decryption key.

29. The method of claim 25, further comprising the step of communicating the single encoded information and at least one decoding scheme to a recipient before the step of decoding the single encoded information.

30. The method of claim 25, further comprising the step of communicating the single encoded information and at least one decoding scheme to two or more recipients before the step of decoding the single encoded information.

31. The method of claim 29, wherein the recipient utilizes the single encoded message, one decoding scheme and device identical to the device used to encode the two or more messages to decode the single encoded information to recover the one of the two or more messages.

32. The method of claim 30, wherein each of the recipients utilize the single encoded message, one decoding scheme and a device identical to the device used to encode the two or more messages to decode the single encoded information to recover the one of the two or more messages such that each of the recipients receives a unique original message.

33. The method of claim 25 wherein the step of encoding the two or more original messages includes the steps of:
providing a device comprising:
one or more geometrical figures, each of the geometrical figures having at least two faces, each of the faces having a front surface, at least three sides and at least three corners, the at least two faces being joined together along one of the sides of each of the faces to produce the geometrical figure, each of the front surfaces, at least three sides and at least three corners each capable of representing a character;
providing a number of geometrical figures equal in amount to the characters of the two or more messages and the single face message having the greatest number of characters;
orienting the geometrical figures identically to one another;
inscribing one of the characters of the face message onto at least one of the front surface, the at least three sides and the at least three corners of each of the geometrical figures such that the entire face message is inscribed onto one or more geometrical figures;
moving the geometrical figures in an identical manner;
inscribing one of the characters a first message of the two or more messages onto at least one of the front surface, the at least three sides and the at least three corners of each of the geometrical figures not inscribed with a character of the face message such that the message of one of the two or more messages is inscribed onto one or more geometrical figures;
rotating the geometrical figures in an identical manner;
inscribing one of the characters a second message of the two or more messages onto at least one of the front surface, the at least three sides and the at least three corners of each of the geometrical figures not inscribed with a character of the face message or the first message such that the message of one of the two or more messages is inscribed onto one or more geometrical figures; and
wherein the manner with which the geometrical figures are rotated before each of the steps of inscribing the geometrical figures produces an encryption/decryption scheme for decrypting one of the two or more messages.

34. The method of claim 33, wherein the single encoded information and one decoding scheme are communicated to one or more recipients before the step of decoding the single encoded information.

35. The method of claim 34, wherein each of the recipients utilize the single encoded message, one decoding scheme and a device identical to the device used to encode the two or more messages to decode the single encoded information to recover the one of the two or more messages such that each of the recipients receives a unique original message.

36. The method of claim 33, wherein the character is chosen from the group consisting of: an alphabetic letter, a mathematical operator, a number, a symbol, or combinations thereof.

37. The method of claim 33, wherein the device may be rotated and inscribed with any number of original messages.

38. A method for transforming information, comprising the steps of:
encoding two or more original messages into a single bit of information; and
decoding the single bit of information using multiple different decoding schemes not requiring the two or more original messages to recover the two or more original messages.
